(19) United States
(12) Patent Application Publication
(10) Pub. No.: US 2024/0362458 A1
(43) Pub. Date: Oct. 31, 2024

(54) TIME SERIES FORECASTING

(71) Applicant: INTERNATIONAL BUSINESS MACHINES CORPORATION, Armonk, NY (US)

(72) Inventors: Nam H. NGUYEN, Pleasantville, NY (US); Yuqi NIE, Princeton, NJ (US); Chandrasekhara K. REDDY, Kinnelon, NJ (US); Dhavalkumar C. PATEL, White Plains, NY (US); Anuradha BHAMIDIPATY, Yorktown Heights, NY (US); Jayant R. KALAGNANAM, Briarcliff Manor, NY (US); Phanwadee SINTHONG, White Plains, NY (US)

(21) Appl. No.: 18/309,268

(22) Filed: Apr. 28, 2023

(51) Int. Cl. G06N 3/0455; G06N 3/0895

(52) U.S. Cl. CPC G06N 3/0455; G06N 3/0895

(57) ABSTRACT

A method, system, and computer program product that is configured to: receive an input time series from an external device in a first system, divide the input time series to a set of univariate time subseries, transform the set of univariate time subseries into a univariate prediction result series using a transformer model, concatenate the univariate prediction result series to a multivariate predictive result, and output the multivariate predictive result for providing time series forecasting to a second system.

### STATEMENT REGARDING PRIOR DISCLOSURES BY THE INVENTOR OR A JOINT INVENTOR

The following disclosure(s) are submitted under 35 U.S.C. 102(b)(1)(A):

DISCLOSURES: Nie et al., “A Time-Series is Worth 64 Words: Long-Term Forecasting with Transformers” published on Mar. 5, 2023, 24 pages, listed in and provided with an Information Disclosure Statement accompanying this application.

### BACKGROUND

Aspects of the present invention relate generally to improved time series forecasting and, more particularly, to a transformer based model for multivariate time series forecasting and self-supervised representation learning.

Manufacturers are integrating new technologies into production facilities and operations, including Internet of Things (IoT), cloud computing and analytics, artificial intelligence (AI), and machine learning. Smart sensors are a useful component for developing smart factories. In particular, smart sensors allow for additional functionality, such as self-monitoring, predictive maintenance, etc.

### SUMMARY

In a first aspect of the invention, there is a computer-implemented method including: receiving, by a processor set, an input time series from an external device in a first system; dividing, by the processor set, the input time series to a set of univariate time subseries; transforming, by the processor set, the set of univariate time subseries into a univariate prediction result series using a transformer model; concatenating, by the processor set, the univariate prediction result series to a multivariate predictive result; and outputting, by the processor set, the multivariate predictive result for providing time series forecasting to a second system.

In another aspect of the invention, there is a computer program product including one or more computer readable storage media having program instructions collectively stored on the one or more computer readable storage media. The program instructions are executable to: receive an input time series from an external device in a first system; divide the input time series to a set of univariate time subseries; pre-train a transformer model using historically reconstructed masked patches; transform the set of univariate time subseries into a univariate prediction result series using the pre-trained transformer model; concatenate the univariate prediction result series to a multivariate predictive result; and output the multivariate predictive result for providing time series forecasting to a second system.

In another aspect of the invention, there is a system including a processor set, one or more computer readable storage media, and program instructions collectively stored on the one or more computer readable storage media. The program instructions are executable to: receive an input time series from an external device in a first system; divide the input time series to a set of univariate time subseries; pre-train a transformer model using historically reconstructed masked patches; transform the set of univariate time subseries to a univariate prediction result series using the pre-trained transformer model; concatenate the univariate prediction result series to a multivariate predictive result; and output the multivariate predictive result for providing time series forecasting to a second system.

In another aspect of the invention, there is a computer-implemented method including receiving, by a processor set, a univariate time series; dividing, by the processor set, the univariate time series into patches; transforming, by the processor set, the patches into a representation using a transformer mode; obtaining, by the processor set, a univariate prediction result series by using a flatten layer with a linear head on the representation; and outputting, by the processor set, the univariate prediction result series.

In another aspect of the invention, there is a computer program product including one or more computer readable storage media having program instructions collectively stored on the one or more computer readable storage media. The program instructions are executable to: receive a univariate time series; divide the univariate time series into a non-overlapped set of patches; mask a subset of the non-overlapped set of patches to a masked patch series; pre-train a transformer model using historically reconstructed masked patches; transform the non-overlapped set of patches to a univariate prediction result series using the pre-trained transformer model; and output the univariate prediction result series.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of a patch time series transformer device in accordance with aspects of the present invention.

FIG. 3 shows a flowchart of an exemplary method of the patch time series transformer device in accordance with aspects of the present invention.

FIG. 4 shows an example of a supervised transformer backbone in accordance with aspects of the present invention.

FIG. 5 shows a flowchart of an exemplary method of the supervised transformer in accordance with aspects of the present invention.

FIG. 6 shows an example of a self supervised transformer backbone in accordance with aspects of the present invention.

FIG. 7 shows a flowchart of an exemplary method of the self supervised transformer backbone in accordance with aspects of the present invention.

FIG. 8 shows examples of graphs of the patch time series transformer device in comparison with other models in accordance with aspects of the present invention.

FIG. 9 shows a table of the computational benefit of the patch time series transform device in accordance with aspects of the present invention.

### DETAILED DESCRIPTION

Aspects of the present invention relate generally to improved time series forecasting and, more particularly, to a transformer based model for multivariate time series forecasting and supervised representation learning. Embodiments of the present invention handle multivariate time series efficiently. Embodiments of the present invention provide a more dynamic way of modeling the multivariate time series in comparison to conventional systems using a single time step. Embodiments of the present invention provide supervised and self-supervised learning techniques with multiple non-linear layers to capture and abstract representation of data.

Embodiments of the present invention provide an efficient design of transformer-based models for multivariate time series forecasting and self-supervised representation learning. Embodiments of the present invention provide patching in the design of transformer-based models for multivariate time series forecasting to enhance locality and capture comprehensive semantic information that is not available in point-level by aggregating time steps into subseries-level patches. Embodiments of the present invention provide channel-independence in the design of transformer-based models for multivariate time series forecasting by using information from a single channel for each transformer input token.

Technical features of aspects of the present invention provide a correlation between data in different time steps. In particular, by extracting local and comprehensive semantic information from subseries-level patches, embodiments of the present invention reduce memory consumption and provide an improved computational gain. The technical features of aspects of the present invention provide channel-independence such that each input token to a transformer-based model only contains information from a single channel. In particular, by providing channel-independence, noisy mixing of information across different channels is avoided and transformer-based model accuracy is improved. The technical features of aspects of the present invention also provide self-supervised representation learning. In particular, by using self-supervised representation learning, pre-training of the transformer-based model can occur to improve the accuracy of the predictive output of the transformer-based model.

An advantage of the aforementioned technical solution for embodiments of the present invention is that memory consumption is reduced, computational gains are improved, and model accuracy is improved. In contrast, conventional systems use a single time step as an input to a transformer-based model, which requires a high memory consumption and high computational resources. Conventional systems also provide mixing of information between channels, which reduces the accuracy of the transformer-based model. Further, conventional systems do not provide self-supervised learning. Thus, the accuracy of the predictive output of the conventional transformer-based model is reduced.

Implementations of aspects of the present invention include utilizing patches to effectively capture local information in a time series and improve computational efficiency. Implementations of aspects of the present invention use independent channels to utilize intra-channel information. In particular, each independent channel is able to capture its own attention maps. Implementations of aspects of the present invention integrate patching and channel independence to improve forecasting performance and reduce computational cost in training transformer models. Implementations of aspects of the present invention group related channels together to capture a correlation of time series within a group. Further, time series across groups attend to their own information.

Aspects of the present invention include a method, system, and computer program product for providing an efficient design of a transformer-based model using multivariate time series forecasting and self-supervised representation learning. For example, a computer-implemented method includes: improving forecasting performance by reducing computing costs in training transformer models, the improving forecasting performance includes capturing local information in a time series using patches that aggregate time steps into subseries level patches, learning average loss across different time series, reducing time and space complexity, and utilizing independent channels. The computer-implemented method also includes capturing correlation of a series within grouping related channels. The computer-implemented method also includes utilizing each channel's representation independently for downstream tasks, utilizing each channels' representation includes applying in downstream tasks where one or more series is missing, and transferring of representation to related tasks where only some series are relevant.

Implementations of aspects of the present invention handle multivariate time series efficiently, provide a more dynamic way of modeling the multivariate time series, and provide supervised and self-supervised learning techniques with multiple non-linear layers to capture and abstract representation of data. Accordingly, implementation aspects of the present invention provide an improvement (i.e., technical solution) to a problem arising in the technical field of providing predictive time series outputs for smart sensors in a manufacturing system. In particular, embodiments of the present invention may include self-supervised representation learning to pre-train using historically reconstructed masked patches to improve the predictive time series outputs. Also, embodiments of the present invention may not be performed mentally or may not be performed in a human mind because aspects of the present invention comprise training transformer-based models and using the trained transformer-based models to improve predictive time series outputs in the manufacturing system.

Implementations of the invention are necessarily rooted in computer technology. For example, the step of training the transformer-based models using reconstructed masked patches for predictive time series outputs is computer-based and cannot be performed in the human mind. Training and using a transformer-based model are, by definition, performed by a computer and cannot practically be performed in the human mind (or with pen and paper) due to the complexity and massive amounts of calculations involved. For example, an artificial neural network, such as the transformer-based model in the embodiments, may have millions or even billions of weights the represent connections between nodes in different layers of the model. Values of these weights are adjusted, e.g., via backpropagation or stochastic gradient descent, when training the model are utilized in calculations when using the trained model to generate an output in real time (or near real time). Given this scale and complexity, it is simply not possible for the human mind, or for a person using pen and paper, to perform the number of calculations involved in training and/or using the transformer-based model.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as time series forecasting code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

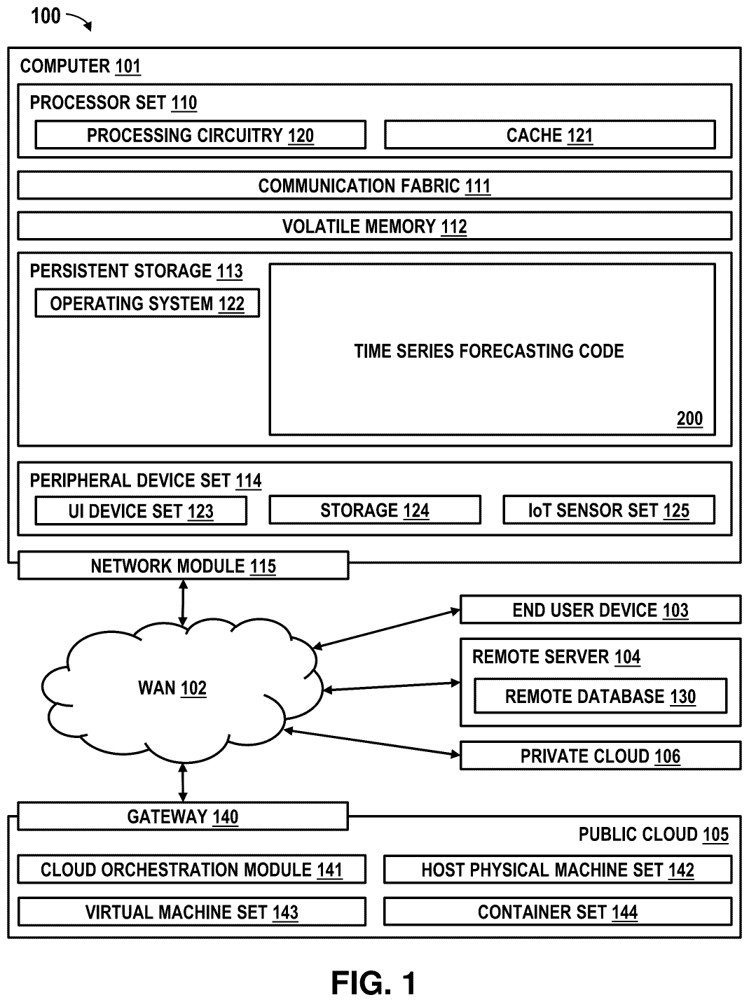

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

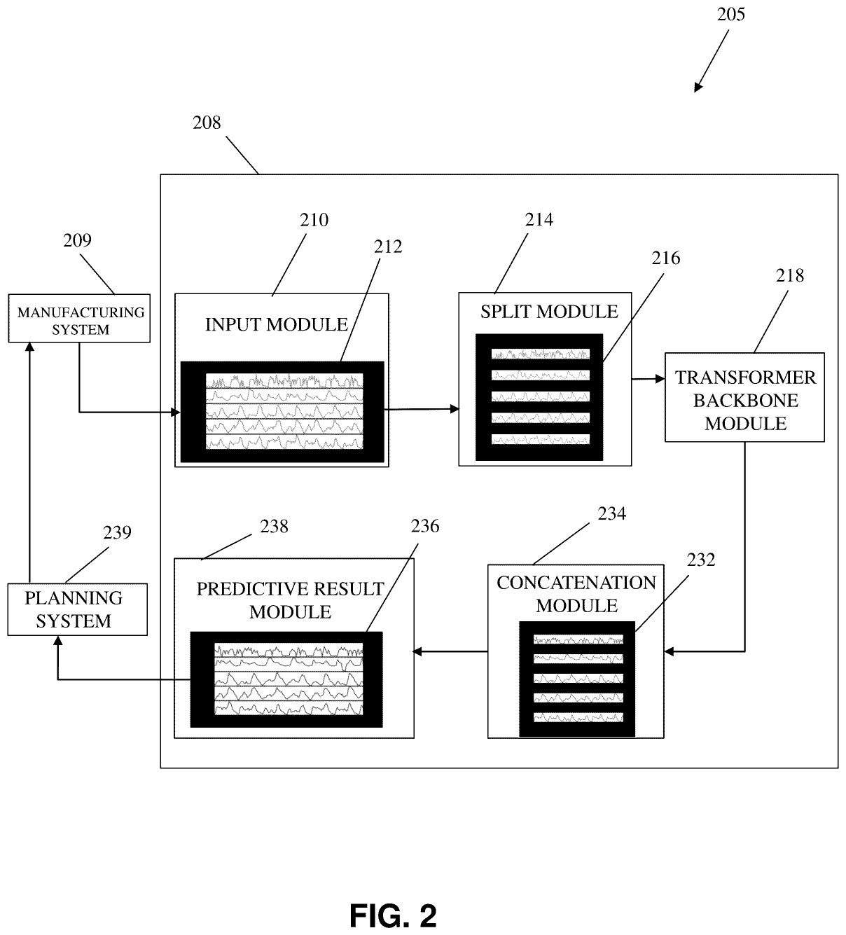

FIG. 2 shows a block diagram of an exemplary environment 205 in accordance with aspects of the invention. In embodiments, the environment 205 includes patch time series transformer server 208, which may comprise one or more instances of the computer 101 of FIG. 1. In other examples, the patch time series transformer server 208 comprises one or more virtual machines or one or more containers running on one or more instances of the computer 101 of FIG. 1.

In embodiments, the patch time series transformer server 208 of FIG. 2 comprises an input module 210, a split module 214, a transformer backbone module 218, a concatenation module 234, and a predictive result module 238, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The patch time series transformer server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the input module 210 receives an input time series 212 from a manufacturing system 209. In embodiments, the input time series 212 is a multivariate time series which is characterized by the following Formula:

$$x ∈ {ℝ}^{M \times L} . \qquad ( Formula 1 )$$

In Formula 1, the length of a look back window of the input time series 212 is represented by L, the vector of the input time series has a dimension M, and R is a batch of predictive results defined by M and L. In particular, the input module 210 receives the input time series 212 from any device in the manufacturing system 209. In an example, the input module 210 receives the input time series 212 from at least one smart sensor (e.g., an external device) in the manufacturing system 209. Further, the input module 210 may receive the input time series 212 from the at least one smart sensor corresponding to at least one manufacturing device of the manufacturing system 209 via a wired and/or wireless network. In embodiments, the input module 210 sends the input time series 212 to the split module 214. In embodiments, the input time series comprises the multivariate time series which includes a multi-channel signal.

In embodiments, the split module 214 divides the input time series 212 to a set of univariate time subseries 216 such that each of the univariate time subseries 216 is represented by the following Formula:

$${x}^{( i )} ∈ {ℝ}^{1 \times L} , i = 1 , … , M . \qquad ( Formula 2 )$$

In Formula 2, each of the univariate time subseries 216 is represented by an integer i which represents each univariate time subseries from a first univariate subseries to a Mth univariate time subseries. Further, each of the univariate time subseries 216 has a fixed dimension of 1. Accordingly, the split module 214 of FIG. 2 decomposes the time input series 212 into subsequences represented by univariate time subseries 216. Further, each of the univariate time subseries 216 have a same model weight as a weight of remaining univariate time subseries of the univariate time subseries 216. In embodiments, the split module 214 sends each of the univariate time subseries 216 to the transformer backbone module 218 according to a channel-independence setting.

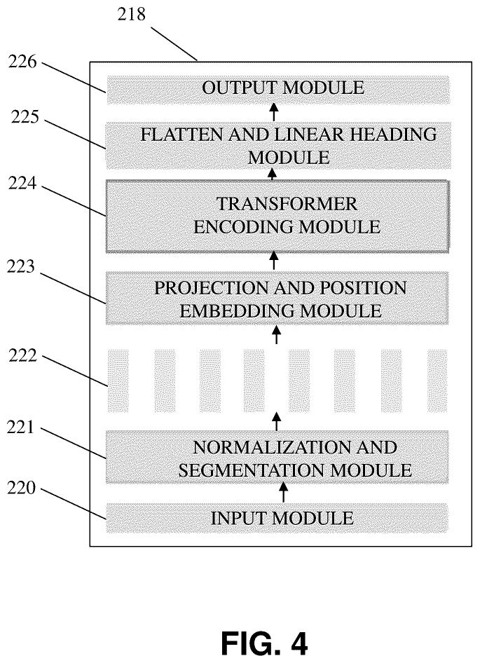

In accordance with aspects of the invention, the transformer backbone module 218 passes each of the univariate time subseries 216 through an instance normalization operator, segments each of the univariate time subseries 216 into patches, performs projection and position embedding, performs transformer encoding, flattens with a linear head, and then outputs the univariate prediction result series 232 to a concatenation module 234. The transformer backbone module 218 learns an average loss across different time series to improve the accuracy of the univariate prediction result series 232. Further, the transformer backbone module 218 has a long context window (i.e., look back window) without any memory bottleneck found in conventional models. The transformer backbone module 218 also reduces time and space complexity in comparison to conventional models. For example, the reduction of time and space complexity is reduced from O*(L/2) to O*((L/P)\hat{ }2), in which L is the input sequence length, O is a number of operations, P is the patch size, L/P=N, and N is a number of input tokens. In this example, by segmenting each of the univariate time subseries 216 into patches, the time and space complexity is reduced quadratically. The details of the transformer backbone module 218 will be described in FIGS. 4-7.

The univariate prediction result series 232 is represented by the following Formula:

$${\hat{x}}^{( i )} ∈ {ℝ}^{1 \times T} , i = 1 , … , M . \qquad ( Formula 3 )$$

In Formula 3, forecast future values are represented by T. In embodiments, the concatenation module 234 concatenates the univariate prediction result series 232 to generate a multivariate predictive result 236 and sends the multivariate predictive result 236 to the predictive result module 238. In embodiments, the concatenation module 234 concatenates the univariate prediction results series 232 by combining each of the univariate prediction result series 232 together to generate the multivariate predictive result 236. In embodiments, the predictive result module 238 sends the multivariate predictive result 236 to a planning system 239 for optimization and decision analysis. In embodiments, the planning system 239 uses the multivariate predictive result 236 to change and/or optimize components of the manufacturing system 209 to reduce errors in a manufacturing process. For example, if the multivariate predictive result 236 indicates that a smart sensor of the manufacturing system 209 is not performing properly (i.e., outputs an error in the multivariate predictive result 236), the planning system 239 can send an alert to the operators of the manufacturing system 209 to investigate and troubleshoot the smart sensor. Alternatively, if the multivariate predictive result 236 indicates that the smart sensor of the manufacturing system 209 is not performing properly (i.e., outputs an error in the multivariate predictive result 236), the planning system 239 can automatically change a software algorithm or setting in the manufacturing system 209 to compensate for the error in the smart sensor of the manufacturing system 209 to reduce downtime. Although the patch time series transformer server 208 in FIG. 2 is used with a manufacturing system 209, embodiments are not limited. In particular, the patch time series transformer server 208 may be used in other systems, such as software, hardware, and/or other industrial, government, and commercial systems.

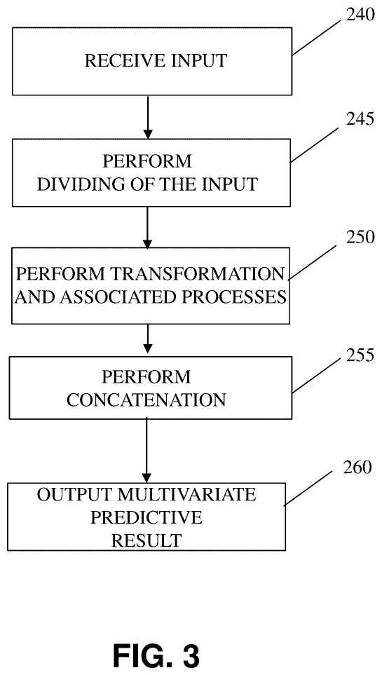

FIG. 3 shows a flowchart of an exemplary method of the patch time series transformer device in accordance with aspects of the present invention. Steps of the method may be carried out in the environment of FIG. 2 and are described with reference to elements depicted in FIG. 2.

At step 240, the system receives, at the input module 210, an input time series 212 from a manufacturing system 209. In embodiments, and as described with respect to FIG. 2, the input module 210 receives the input time series 212 from the at least one smart sensor corresponding to at least one manufacturing device in the manufacturing system 209 via a wired and/or wireless network and sends the input time series 212 to a split module 214.

At step 245, the system divides, at the split module 214, the input time series 212 to a set of univariate time subseries 216. In embodiments, and as described with respect to FIG. 2, the split module 214 sends each of the univariate time subseries 216 to the transformer backbone module 218.

At step 250, the system performs, at the transformation backbone module 218, transformation and associated processes. In embodiments, and as described with respect to FIG. 2, the transformer backbone module 218 passes each of the univariate time subseries 216 through an instance normalization operator, segments each of the univariate time subseries 216 into patches, performs projection and position embedding, performs transformer encoding, flattens with a linear head, and then outputs the univariate prediction result series 232 to a concatenation module 234.

At step 255, the system performs, at the concatenation module 234, concatenation of the univariate prediction result series 232. In embodiments, and as described with respect to FIG. 2, the concatenation module 234 sends the multivariate predictive result 236 to the predictive result module 238. At step 260, the system outputs, at the predictive result module 238, the multivariate predictive result 236 to a planning system 239. In embodiments, and as described with respect to FIG. 2, the planning system 239 uses the multivariate predictive result 236 to change and/or optimize components of the manufacturing system 209 to reduce errors in a manufacturing process.

FIG. 4 shows an example of a supervised transformer backbone in accordance with aspects of the present invention. In FIG. 4, the transformer backbone module 218 comprises an input module 220, a normalization and segmentation module 221, patches 222, projection and position embedding module 223, transformer encoding module 224, flatten and linear heading module 225, and an output module 226. The transformer backbone module 218 may include additional or fewer modules than those shown in FIG. 4. In embodiments, separate modules may be integrated into a single module. Additionally, or alternatively, a single module may be implemented as multiple modules. Moreover, the quantity of devices and/or networks in the transformer backbone module 218 is not limited to what is shown in FIG. 4. In practice, the transformer backbone module 218 may include additional devices and/or networks; fewer devices and/or networks; different devices and/or networks; or differently arranged devices and/or networks than illustrated in FIG. 4.

In FIG. 4, the input module 220 of the transformer backbone module 218 receives each of the univariate time subseries 216 from the split module 214. The input module 220 then sends each of the univariate time subseries 216 to a normalization and segmentation module 221. The normalization and segmentation module 221 divides each of the univariate time subseries 216 into patches 222 which can be either overlapped or non-overlapped. Further, the patches 222 comprise local and semantic information in aggregated time steps. In particular, the normalization and segmentation module 221 will normalize and segment into patches 222 as defined by the following Formula:

$${x}_{p}^{( i )} ∈ {R}^{P \times N} . \qquad ( Formula 4 )$$

In Formula 4, N is a resulting number of patches 222 such that N=((L−P)/S)+2, where L is a look back window of the input time series 212 is represented by L, a patch length is represented by P, and a non-overlapping region between two consecutive patches is represented as S. In embodiments, by performing normalizing and segmenting into patches 222, a number of input tokens to the transformer encoding module 224 is reduced from L to approximately L/S. Accordingly, memory usage and computational complexity of an attention map related to each channel are quadratically decreased by the factor of S. The normalization and segmentation module 221 sends the patches 222 to the projection and position embedding module 223.

The projection and position embedding module 223 maps the patches 222 to a transformer latent space of dimension D. Further, after the projection and position embedding module 223 maps the patches 222 to the transformer latent space of dimension D, the projection and position embedding module 223 applies a learnable additive position encoding to monitor a temporal order of the patches 222. Accordingly, the projection and position embedding module 223 applies the learnable additive position encoding, which provides an embedded group of time steps to preserve local information in hidden variables. Further, in embodiments, the embedded group of time steps may be different over different groups of time series. Also, in embodiments, spatio-temporal collection may be designed across time series. As a result of the projection and position embedding module 223 mapping and the applying the learnable additive position encoding to the patches 222, modified patches are generated and defined by the following Formula:

$${x}_{d}^{( i )} ∈ {R}^{D \times N} . \qquad ( Formula 5 )$$

The projection and position embedding module 223 sends the modified patches as defined by Formula 5 to the transformer encoding module 224. The transformer encoding module 224 transforms the modified patches as defined by Formula 5 into query matrices, key matrices, and value matrices. Then, the transformer encoding module 224 uses a scaled production and a feed forward network with residual connections to generate a representation as defined by the following Formula:

$${z}^{( i )} ∈ {R}^{D \times N} . \qquad ( Formula 6 )$$

The transformer encoding module 224 sends the representation as defined by Formula 6 to the flatten and linear heading module 225. The flatten and linear heading module 225 uses a flatten layer with a linear head to obtain the univariate prediction result series 232 as defined by Formula 3 above. The flatten and linear heading module 225 then sends the univariate prediction result series 232 to the output module 226. The output module 226 will send the univariate prediction result series 232 to the concatenation module 234 in FIG. 2.

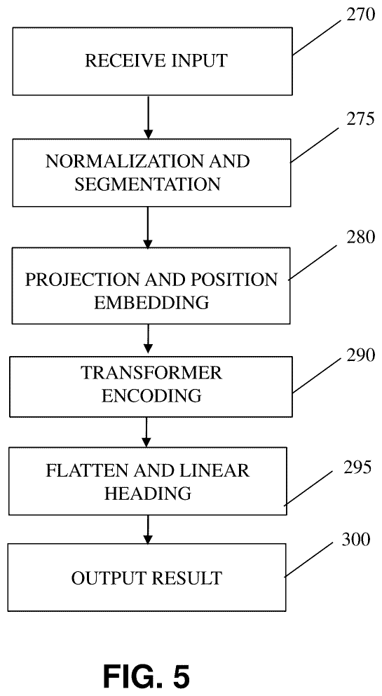

FIG. 5 shows a flowchart of an exemplary method of the supervised transformer in accordance with aspects of the present invention. Steps of the method may be carried out in the transformer backbone module 218 of FIG. 4 and are described with reference to elements depicted in FIG. 4.

At step 270, the system receives, at the input module 220 of the transformer backbone module 218, each of the univariate time subseries 216 from the split module 214. In embodiments, and as described with respect to FIG. 4, the input module 220 of the transformer backbone module 218 sends each of the univariate time subseries 216 to a normalization and segmentation module 221.

At step 275, the system divides, at the normalization and segmentation module 221 of the transformer backbone module 218, each of the univariate time subseries 216 into patches 222. In embodiments, and as described with respect to FIG. 4, the normalization and segmentation module 221 of the transformer backbone module 218 normalizes and segments each of the univariate time subseries 216 into the patches 222. Further, the normalization and segmentation module 221 sends the patches 222 to the projection and position embedding module 223.

At step 280, the system performs, at the projection and position embedding module 223 of the transformer backbone module 218, mapping of the patches 222 to a latent space of dimension D and applying a learnable additive position encoding to monitor a temporal order of the patches 222. In embodiments, and as described with respect to FIG. 4, the projection and position embedding module 223 generates the modified patches as a result of the mapping and applying to the patches 222 and sends the modified patches to the transformer encoding module 224.

At step 290, the system performs, at the transformer encoding module 224 of the transformer backbone module 218, transformation of the modified patches. In embodiments, and as described with respect to FIG. 4, the transformer encoding module 224 transforms the modified patches into query matrices, key matrices, and value matrices, uses a scaled production and a feed forward network with residual connections to generate a representation, and sends the representation to the flatten and linear heading module 225.

At step 295, the system obtains, at the flatten and linear heading module 225, the univariate prediction result series 232 by using a flatten layer with a linear head. In embodiments, and as described with respect to FIG. 4, the flatten and linear heading module 225 sends the univariate results series 223 to the output module 226. At step 300, the system outputs, at the output module 226, the univariate prediction result series 232 to the concatenation module 234 in FIG. 2.

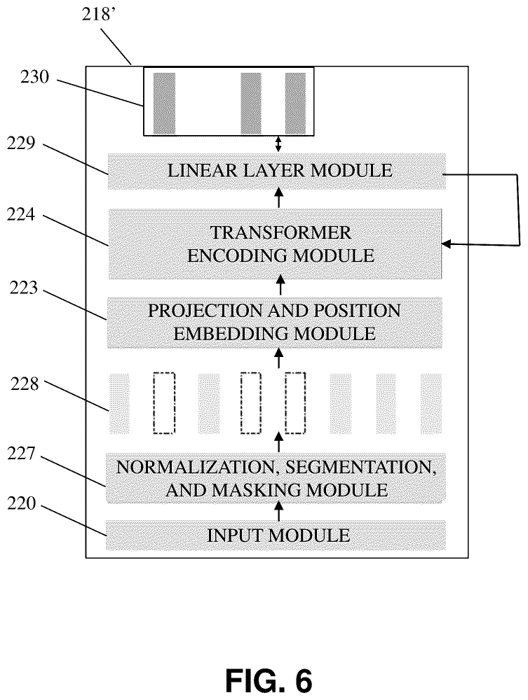

FIG. 6 shows an example of a self supervised transformer backbone in accordance with aspects of the present invention. In FIG. 6, the self supervised transformer backbone module 218′ comprises the input module 220, the projection and position embedding module 223, the transformer encoding module 224, a normalization, segmentation, and masking module 227, masked patch series 228, a linear layer module 229, and reconstructed masked patches 230. The transformer backbone module 218′ may include additional or fewer modules than those shown in FIG. 6. In embodiments, separate modules may be integrated into a single module. Additionally, or alternatively, a single module may be implemented as multiple modules. Moreover, the quantity of devices and/or networks in the transformer backbone module 218′ is not limited to what is shown in FIG. 6. In practice, the self supervised transformer backbone module 218′ may include additional devices and/or networks; fewer devices and/or networks; different devices and/or networks; or differently arranged devices and/or networks than illustrated in FIG. 6.

In FIG. 6, the input module 220 of the self-supervised transformer backbone module 218′ receives each of the univariate time subseries 216 from the split module 214. The input module 220 then sends each of the univariate time subseries 216 to a normalization, segmentation, and masking module 227. The normalization, segmentation, and masking module 227 divides each of the univariate time subseries 216 into a non-overlapped series and then masks a random subset of patches with zero values (i.e., zero values represent no information within the masked patch series). The output of the normalization, segmentation, and masking module 227 is shown as the masked patch series 228 which includes both non-masked patch subseries (in gray) and masked patch subseries (dotted lines indicating the masking with zero values). Further, the normalization, segmentation, and masking module 227 sends the masked patch series 228 to the projection and position embedding module 223.

The projection and position embedding module 223 maps the masked patch series 228 to a transformer latent space of dimension D. Further, after the masked patch series 228 is mapped to the transformer latent space of dimension D, the projection and position embedding module 223 applies a learnable additive position encoding to monitor a temporal order of the masked patch series 228. Accordingly, the projection and position embedding module 223 applies the learnable additive position encoding, which provides an embedded group of time steps to preserve local information in hidden variables. Further, in embodiments, the embedded group of time steps may be different over different groups of time series. Also, in embodiments, spatio-temporal collection may be designed across time series. As a result of the mapping and the applied learnable additive position encoding, the masked patch series 228 are defined by Formula 5 above.

The projection and position embedding module 223 sends the masked patch series 228 to the transformer encoding module 224. The transformer encoding module 224 in FIG. 6 is pre-trained with a mean squared error (MSE) loss which corresponds with an average squared difference between predicted values (i.e., the multivariate predictive result 236) and actual target values (i.e., the multivariate true result). Accordingly, the transformer encoding module 224 is trained with the MSE loss to reconstruct the masked patch subseries (dotted lines indicating the masking with zero values) in the masked patch series 228. The transformer encoding module 224 also transforms the masked patch series 228 as defined by Formula 5 into query matrices, key matrices, and value matrices. Then, the transformer encoding module 224 uses a scaled production and a feed forward network with residual connections to generate a representation as defined by Formula 6 above.

The transformer encoding module 224 sends the representation as defined by Formula 6 and the reconstructed masked patch subseries 230 to the linear layer module 229. The linear layer module 229 uses a linear layer of the representation to obtain the univariate prediction result series 232 as defined by Formula 3 above. The linear layer module 229 then outputs the univariate prediction result series 232 to the concatenation module 234 in FIG. 2. Further, the linear layer module 229 will also output the reconstructed masked patch subseries 230 to the transformer encoding module 224 to re-train the transformer encoding module 224. Accordingly, the transformer encoding module 224 is trained multiple times to reduce the MSE loss and provide a more accurate predictive result (i.e., the multivariate predictive result 236). By re-training the transformer encoding module 224, the transformer backbone module 218′ is self-supervised by using an automatic and iterative training approach of the transformer encoding module 224 to improve accuracy of the predictive result (i.e., the multivariate predictive result 236).

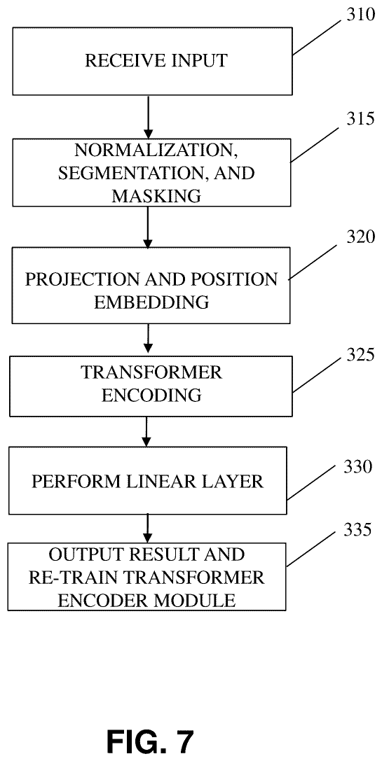

FIG. 7 shows a flowchart of the self supervised transformer backbone in accordance with aspects of the present invention. Steps of the method may be carried out in the transformer backbone module 218′ of FIG. 6 and are described with reference to elements depicted in FIG. 6.

At step 310, the system receives, at the input module 220 of the self supervised transformer backbone module 218′, each of the univariate time subseries 216 from the split module 214. In embodiments, and as described with respect to FIG. 6, the input module 220 of the self supervised transformer backbone module 218′ sends each of the univariate time subseries 216 to a normalization, segmentation, and masking module 227.

At step 315, the system performs, at the normalization, segmentation, and masking module 227 of the self supervised transformer backbone module 218′, dividing of each of the univariate time subseries 216 into a non-overlapped series and masking of a random subset of patches with zero values (i.e., zero values represent no contained information within the masked series patches). In embodiments, and as described with respect to FIG. 6, the normalization, segmentation, and masking module 227 outputs the masked patch series 228 which includes both a non-masked patch subseries and a masked patch subseries. The normalization, segmentation, and masking module 227 sends the masked patch series 228 to the projection and position embedding module 223.

At step 320, the system performs, at the projection and position embedding module 223 of the transformer backbone module 218′, mapping of the masked patch series 228 to a transformer latent space of dimension D and applying of a learnable additive position encoding to monitor a temporal order of the masked patch series 228. In embodiments, and as described with respect to FIG. 6, the projection and position embedding module 223 sends the masked patch series 228 to the transformer encoding module 224.

At step 325, the system performs, at the transformer encoding module 226, transformation of the masked patch series 228 into query matrices, key matrices, and value matrices. In embodiments, and as described with respect to FIG. 6, the transformer encoding module 226 uses a scaled production and a feed forward network with residual connections to generate a representation. The transformer encoding module 226 is also pre-trained with a MSE loss between predicted values (i.e., the multivariate predictive result 236) and actual target values to reconstruct the masked patch subseries in the masked patch series 228. The transformer encoding module 226 sends the representation and the reconstructed masked patch subseries 230 to the linear layer module 229.

At step 330, the system obtains, at the linear layer module 229, the univariate prediction result 232 by using a linear layer of the representation. At step 335, the system, outputs, at the linear layer module 226, the univariate prediction result 232 to the concatenation module 234 in FIG. 2 and the reconstructed masked patch subseries 230 to the transformer encoding module 226. In embodiments, and as described with respect to FIG. 6, the transformer encoding module 226 will be re-trained based on the reconstructed masked patch subseries 230.

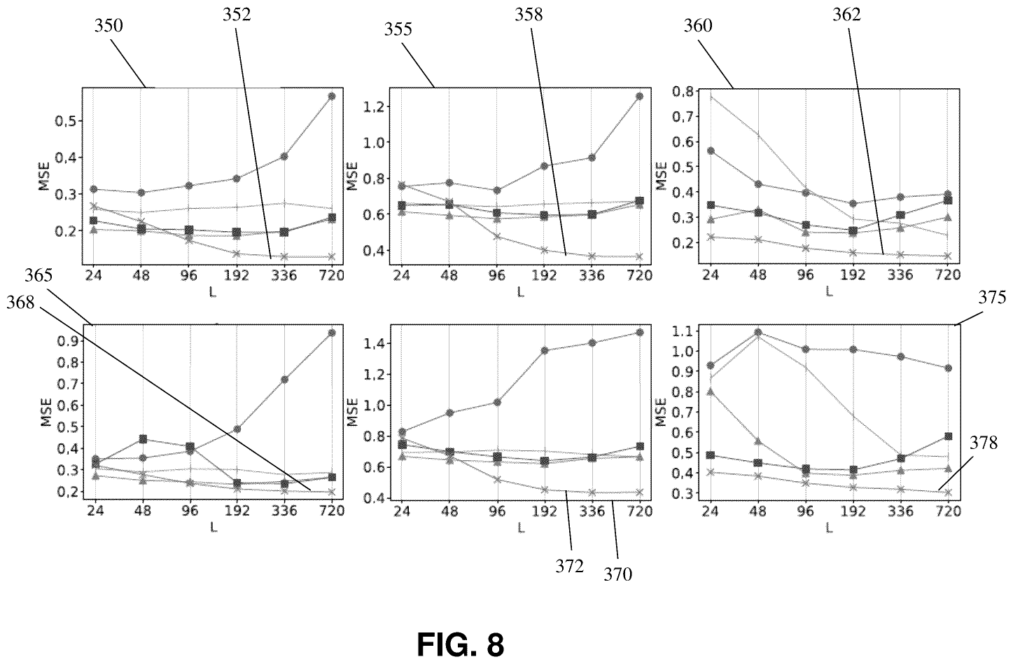

FIG. 8 shows examples of graphs of the patch time series transformer server 208 in comparison with other models in accordance with aspects of the present invention. For example, a graph 350 corresponds with an electricity dataset with a prediction length T=96 and includes the mean squared error (MSE) loss on the y-axis and the look back window L on the x-axis. In the graph 350, a graphed line 352 generated in accordance with aspects of the present invention has a lower MSE loss as the look back window L becomes greater than 96 than remaining conventional models (represented by the remaining graphed lines in the graph 350). A graph 355 corresponds with a traffic dataset with the prediction length T=96. In the graph 355, a graphed line 358 generated in accordance with aspects of the present invention has a lower MSE loss as the look back window L becomes greater than 96 than remaining conventional models (represented by the remaining graphed lines in the graph 355). A graph 360 corresponds with a weather dataset with the prediction length T=96. In the graph 360, a graphed line 362 generated in accordance with aspects of the present invention has a lower MSE loss at all look back windows L between 24 and 720 than remaining conventional models (represented by the remaining graphed lines in the graph 360).

In FIG. 8, a graph 365 corresponds with an electricity dataset with a prediction length T=720 and includes the MSE loss on the y-axis and the look back window L on the x-axis. In the graph 365, a graphed line 368 generated in accordance with aspects of the present invention has a lower MSE loss at all look back windows L between 24 and 720 than remaining conventional models (represented by the remaining graphed lines in the graph 365). A graph 370 corresponds with a traffic dataset with the prediction length T=720. In the graph 370, a graphed line 372 generated in accordance with aspects of the present invention has a lower MSE loss as the look back window L becomes greater than 96 than remaining conventional models (represented by the remaining graphed lines in the graph 370). A graph 375 corresponds with a weather dataset with the prediction length T=720. In the graph 375, a graphed line 378 generated in accordance with aspects of the present invention has a lower MSE loss at all look back windows L between 24 and 720 than remaining conventional methods (represented by the remaining graphed lines in the graph 375). As shown in embodiments of FIG. 8, the predictive accuracy of the patch time series transformer server 208 in accordance with aspects of the present invention (as represented by MSE loss) is lower as the look back window L is increased than conventional models.

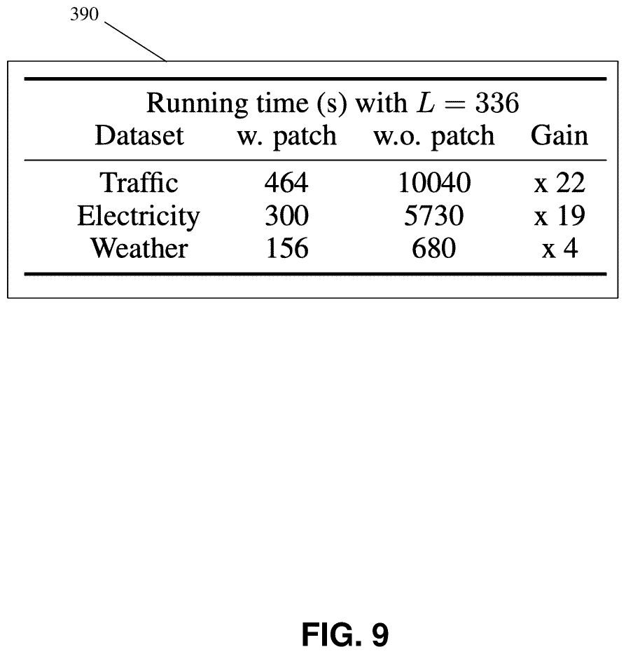

FIG. 9 shows a table of the computational benefit of the patch time series transform device in accordance with aspects of the present invention. In FIG. 9, a table 390 shows that aspects of the present invention provide a 22 times computational gain in running time for a traffic dataset when using the patch time series transformer server 208 with aspects of the present invention in comparison to conventional models. Further, in FIG. 9, the table 390 shows that aspects of the present invention provide a 19 times computational gain in running time for an electricity dataset when using the patch time series transformer server 208 with aspects of the present invention in comparison to conventional models. In FIG. 9, the table 390 also shows that aspects of the present invention provide a 4 times computation gain in turning time for a weather dataset when using the patch time series transformer server 208 with aspects the present invention in comparison to conventional models.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, an input time series from an external device in a first system;
dividing, by the processor set, the input time series to a set of univariate time subseries;
transforming, by the processor set, the set of univariate time subseries into a univariate prediction result series using a transformer model;
concatenating, by the processor set, the univariate prediction result series to a multivariate predictive result; and
outputting, by the processor set, the multivariate predictive result for providing time series forecasting to a second system.

2. The method of claim 1, wherein the external device comprises a smart sensor, the first system comprises a manufacturing system, and the second system comprises a planning system in communication with the first system.

3. The method of claim 1, wherein the input time series comprises a multivariate time series.

4. The method of claim 3, wherein the multivariate time series comprises a multi-channel signal.

5. The method of claim 1, wherein the transforming the set of univariate time subseries into the univariate prediction result series comprises normalizing and segmenting the univariate time subseries into patches.

6. The method of claim 5, wherein the patches are local and semantic information in aggregated time steps.

7. The method of claim 5, wherein the transforming the set of univariate time subseries into the univariate prediction result series further comprises transforming the patches into a representation.

8. The method of claim 7, wherein the transforming the set of univariate time series into the univariate prediction result series further comprises utilizing a flatten layer with a linear head on the representation to obtain the univariate prediction result series.

9. The method of claim 1, wherein the univariate time subseries comprises a plurality of channel independent signals.

10. The method of claim 9, wherein each of the channel independent signals have a same model weight as a weight of remaining channel independent signals.

11. The method of claim 1, wherein the transformer model comprises a supervised model.

12. A computer program product comprising one or more computer readable storage media having program instructions collectively stored on the one or more computer readable storage media, the program instructions executable to:
receive an input time series from an external device in a first system;
divide the input time series to a set of univariate time subseries;
pre-train a transformer model using historically reconstructed masked patches;
transform the set of univariate time subseries into a univariate prediction result series using the pre-trained transformer model;
concatenate the univariate prediction result series to a multivariate predictive result; and
output the multivariate predictive result for providing time series forecasting to a second system.

13. The computer program product of claim 12, wherein the external device comprises a smart sensor, the first system comprises a manufacturing system, and the second system comprises a planning system in communication with the manufacturing system.

14. The computer program product of claim 12, wherein the input time series comprises a multivariate time series.

15. The computer program product of claim 14, wherein the multivariate time series comprises a multi-channel signal.

16. The computer program product of claim 15, wherein the transforming the set of univariate time subseries into the univariate prediction result series comprises normalizing, segmenting, and masking the univariate time subseries into masked patches and non-masked patches.

17. The computer program product of claim 16, wherein the transforming the set of univariate time subseries into the univariate prediction result series further comprises utilizing a linear layer on the non-masked patches to obtain the univariate prediction result series.

18. The computer program product of claim 17, wherein the transforming the set of univariate time subseries into the univariate prediction results series further comprises reconstructing the masked patches.

19. The computer program product of claim 12, wherein the univariate time subseries comprises a plurality of channel independent signals.

20. The computer program product of claim 19, wherein each of the channel independent signals have a same model weight as a weight of remaining channel independent signals.

21. The computer program product of claim 12, wherein the transformer model comprises a self-supervised model.

22. A system comprising:
a processor set, one or more computer readable storage media, and program instructions collectively stored on the one or more computer readable storage media, the program instructions executable to:
receive an input time series from an external device in a first system;
divide the input time series to a set of univariate time subseries;
pre-train a transformer model using historically reconstructed masked patches;
transform the set of univariate time subseries into a univariate prediction result series using the pre-trained transformer model;
concatenate the univariate prediction result series to a multivariate predictive result; and
output the multivariate predictive result for providing time series forecasting to a second system.

23. The system of claim 22, wherein the transforming the set of univariate time subseries into the univariate prediction result series comprises normalizing, segmenting, and masking the univariate time subseries into masked patches and non-masked patches.

24. A method, comprising:
receiving, by a processor set, a univariate time series;
dividing, by the processor set, the univariate time series into patches;
transforming, by the processor set, the patches into a representation using a transformer model;
obtaining, by the processor set, a univariate prediction result series by using a flatten layer with a linear head on the representation; and
outputting, by the processor set, the univariate prediction result series.

25. A computer program product comprising one or more computer readable storage media having program instructions collectively stored on the one or more computer readable storage media, the program instructions executable to:
receive a univariate time series;
divide the univariate time series into a non-overlapped set of patches;
mask a subset of the non-overlapped set of patches to a masked patch series;
pre-train a transformer model using historically reconstructed masked patches:
transform the non-overlapped set of patches to a univariate prediction result series using the pre-trained transformer model; and
output the univariate prediction result series.
